(19) United States
(12) Patent Application Publication
(10) Pub. No.: US 2018/0320424 A1
(43) Pub. Date: Nov. 8, 2018

(54) Hinge device with the possibility of breather opening

(71) Applicant: C.M.I. CERNIERE MECCANICHE INDUSTRIALI S.R.L., Valsamoggia (IT)

(72) Inventor: Eros GHERARDI, Bologna (IT)

(73) Assignee: C.M.I. CERNIERE MECCANICHE INDUSTRIALS S.R.L., Valsamoggia (IT)

(21) Appl. No.: 15/772,913

(22) PCT Filed: Nov. 8, 2016
(86) PCT No.: PCT/EP2016/076989

§ 371 Date: May 2, 2018

(30) Foreign Application Priority Data
Nov. 10, 2015 (IT) 102015000070943

(51) Int. Cl. E05D 7/086; E05F 1/12; F24C 15/02; A47L 15/42; E05D 11/08

(52) U.S. Cl. CPC E05D 7/086; E05F 1/1261; E05F 5/00; A47L 15/4261; E05D 11/087; F24C 15/023

(57) ABSTRACT

A hinge device includes a first connection means (3) assigned to be fixed to a structure or frame and rotatably connected to a second connection means (5) assigned to be fixed to a door device (1) comprises at least one interconnecting means (7) connected to a sliding means (13) and a friction means (17) with at least one friction sliding block (25) secured to the sliding means (13) and sliding along a respective sliding wall (27) of the first connection means (3) and parallel to a direction of translation of the sliding means (13), wherein at least one arrest means (19) is fixed or made in the first connection means (3) in proximity to a sliding wall (27) to abut with the sliding means (13) to arrest its stroke towards the closing of the door or of the shutter in correspondence to the breather opening condition (S).

### TECHNICAL FIELD

The present invention relates to the field concerning the hinges for dishwasher and for other apparatuses such as, for example, for ovens or the like and in particular it refers to a hinge device with the possibility of breather opening to allow the outflow of steam at the end of washing, or during or after cooking.

### PRIOR ART

The known dishwasher hinges allow the opening and closing of the door having a horizontal and lower axis of rotation, balancing the weight of said door. At the end of wash operations, the dishwashers perform a final heating phase of the dishes after which the user should open the door, at least a few degrees, to allow the outflow of steam. Omitting the opening of the door at the right time, the steam remains inside the dishwasher and, as a result of the cooling, the steam condenses wetting again the dishes and the interior of the dishwasher. Often happens that the user forgets to open the door or that the opening is insufficient for example due to the elastic closing force applied to the door by the elastic bodies of the known hinges.

A further disadvantage of the known hinges consists in that they can allow an unintentional opening of the door starting from the opening to some small degree to allow for the outflow of steam from the steam breather and then having the door unintentionally continue opening by itself so as to open totally and to end up occupying part of the floor area, thereby creating a tripping hazard for unsuspecting bystanders.

Electric control for door locks are known and sometimes they can provide a small elastic opening push. Such locks can be applied to the dishwasher to program the opening at the end of the washing cycles but the elastic force of the hinges, required to balance the weight of the door, prevents the latter to be open enough to allow venting.

### DISCLOSURE OF INVENTION

One object of the present invention is to propose a hinge device with the possibility of breather opening that, in the early stages of opening or up to a few degrees of opening, for example from about 8° to about 20° preferably about 11° , don't transmit to the door elastic closing force and/or friction forces that oppose the opening.

Another object is to propose a hinge device that from the breather opening condition to the total opening condition and vice versa, is able to balance the weight of the door and to brake the rotation thereof.

Another object of the invention is to propose a hinge device that is able to provide the door with a small elastic opening push towards said opening breather condition to facilitate the initial door opening phase in response to the opening of the lock.

### BRIEF DESCRIPTION OF THE DRAWINGS

The characteristics of the invention are shown in the following with particular reference to the attached drawings in which:

FIG. 1 shows a front and partial view of the hinge device with the possibility of breather opening, object of the present invention, in a closed condition;

FIG. 2 shows an enlarged view of a detail of FIG. 1;

FIG. 3 shows an axonometric isometric view of a first connection means of FIG. 1;

FIG. 4 shows an enlarged view of a detail of FIG. 3 to better illustrate respective arrest means;

FIG. 5 shows a front and enlarged view of an interconnection means of FIG. 1;

FIG. 6 illustrates a front view of the hinge device with the possibility of breather opening of FIG. 1 in an open breather condition of 11° and in which respective elastic means are shown in a schematic and partial way;

FIG. 7 shows an enlarged view of a detail of FIG. 6;

FIG. 8 shows a front view of the hinge device with the possibility of breather opening of FIG. 1 in a not fully open condition and in a phase of rotation toward the complete opening, shown by the large tilted arrow, wherein the elastic force carried by the elastic means, not shown, is represented by a smaller tilted arrow pointing vertically upwards;

FIG. 9 is an enlarged view of a detail of FIG. 8;

FIG. 10 shows a front view of the hinge device with the possibility of breather opening of FIG. 1 in a not fully opened condition, corresponding to that of FIG. 8 but in a rotation condition toward the closure shown by the large arrow tilted, wherein the elastic force carried by elastic means, not shown, is represented by a smaller surrounded arrow pointing vertically upwards;

FIG. 11 shows an enlarged view of a detail of FIG. 10;

FIG. 12 shows a front view and in the closed condition of a variant of the device of FIG. 1;

FIGS. 13 and 14 show, by their respective points of view, axonometric and exploded views of a pusher means of FIG. 12.

### DETAILED DESCRIPTION

With reference to figures from 1 to 11, 1 indicates the hinge device with the possibility of breather opening object of the present invention comprising a first connection means 3 assigned to be fixed to a structure or frame of a dishwasher or of another device with a door having horizontal and bottom axis of rotation.

The first connection means 3 is rotatably connected, by a hinge pin 4 whose axis of rotation defines the rotation axis of the door, to a second connection means 5 assigned to be fixed to said door or shutter of the dishwasher or of the other appliance.

The hinge device 1 also comprises at least one interconnection means 7 consisting of a shaped connecting rod having a first end connected to the second connection means 5 by a first connecting pin 9 and a second end connected, by a second connecting pin 11, to a sliding means 13 constrained to translate along the first connection means 3.

Said sliding means 13 is connected to, or is provided with, an elastic means 15, schematically and partially shown in FIG. 6, and it 13 is connected to a friction means 17 assigned to transmit to the second connection means 5, by the interconnection means 7, respectively an elastic force directed in the direction of the extreme closing condition C of the door or shutter and a friction force directed in opposition to the rotation of the door or shutter.

The device 1 also comprises an arrest means 19 assigned to abut with the sliding means 13 or preferably with a member of the friction means 17 in an end portion of the closing rotation of the door or shutter arresting the sliding means 13 in correspondence of an open breather condition S of the door or shutter putting this door or shutter, in the open breather condition S, out of the action of the elastic closure force and by the frictional force produced by the friction means. The second connecting pin 11 is rigidly fixed to the sliding means 13 and it is housed with clearance in a respective seat 21 made in the second end of the interconnection means 7 and said seat 21 is shaped in the form of a slot elongated in the motion direction of the sliding means towards the closed condition C of the door or shutter. Alternatively, the second connecting pin 11 may instead be rigidly secured to the second end of the interconnection means 7 and be housed with clearance in a respective seat 21 obtained in the sliding means 13.

The shape of the seat 21 for the second connecting pin 11 allows the connection means 5 and the door or shutter to carry out the final portion of closing rotation of the door or shutter from the open breather condition S to the extreme closing condition C and the corresponding reverse rotation while the sliding means 13 abut with the arrest means 19 which prevent further translation of the sliding means 13.

The friction means 17 provides the second connection means 5 with a force friction higher in intensity or in module of the elastic force given to the second connection means 5 by the elastic means 15.

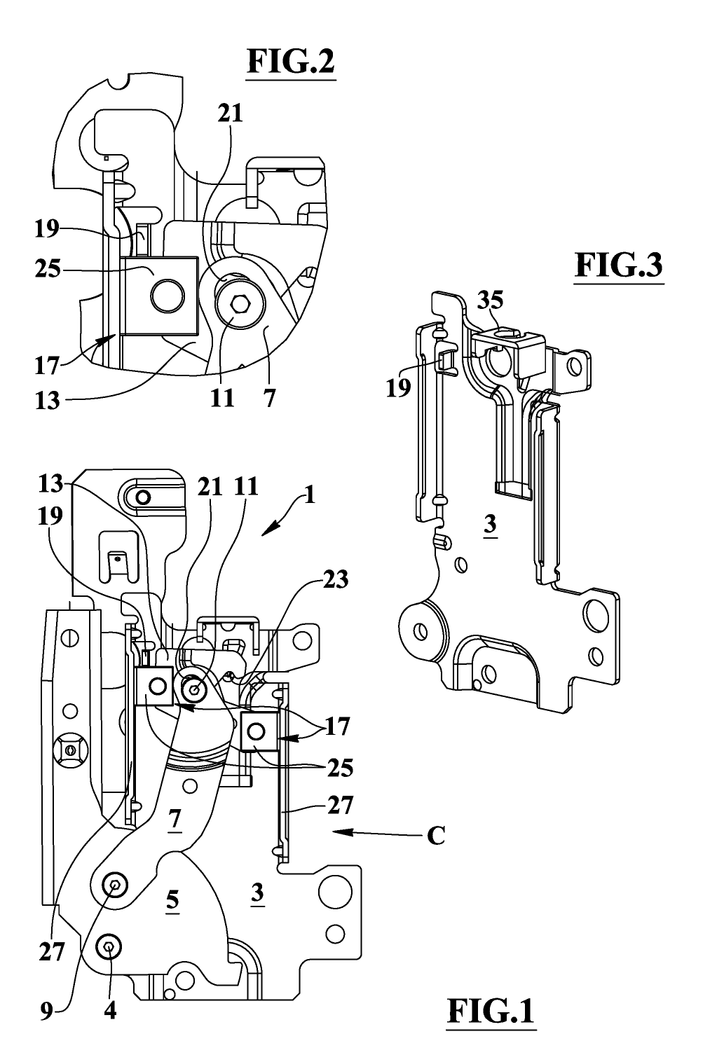

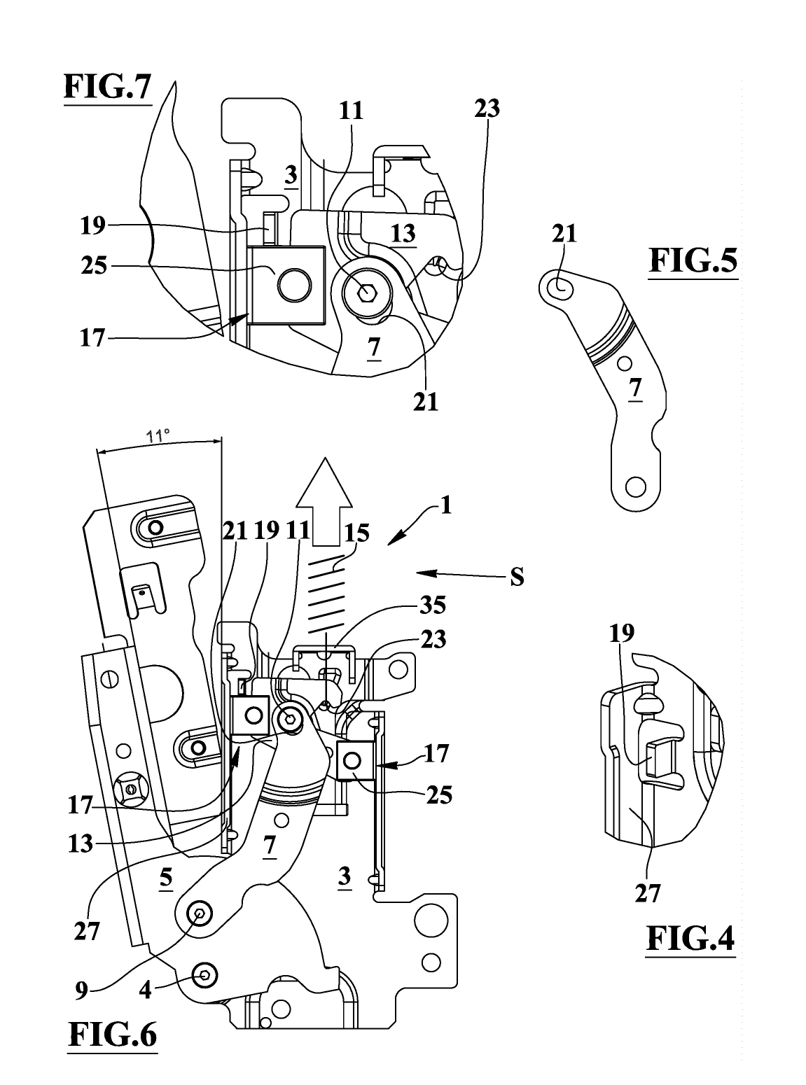

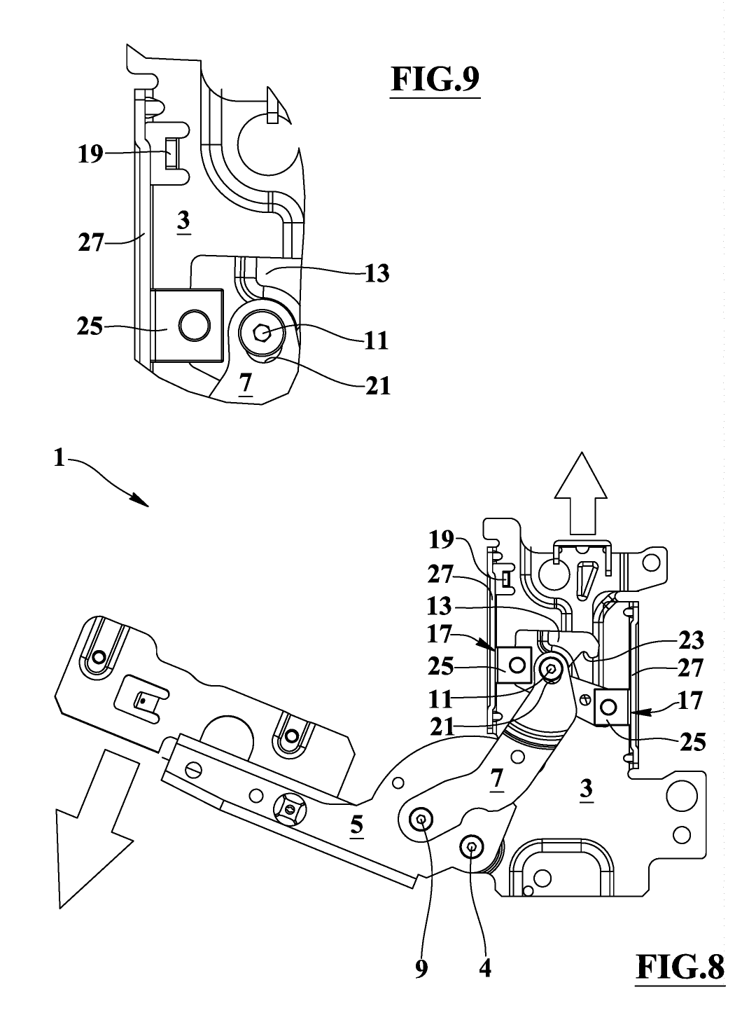

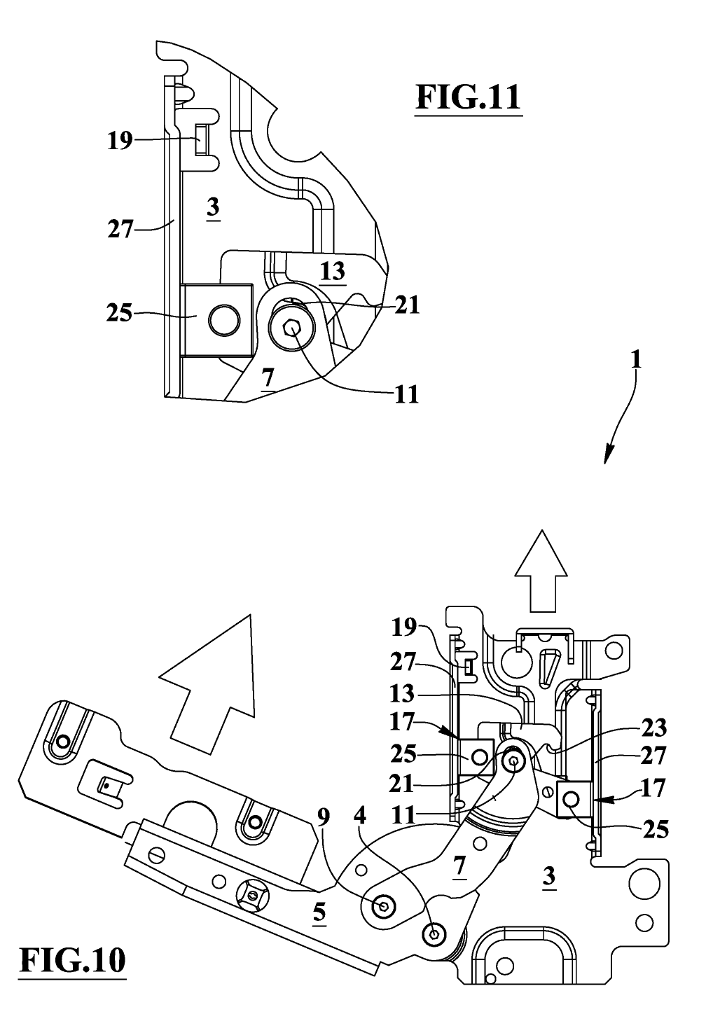

The sliding means 13 consists of a rocker arm whose median portion is engaged to the second connecting pin 11. The friction means 17 comprise at least one friction sliding block 25, preferably two as shown in FIGS. 1 to 11, and placed at opposite positions with respect to the second connecting pin 11. Each friction sliding block 25 is secured to the sliding means 13 by a respective pin and slides along a respective sliding wall 27 of the first connection means 3, said sliding wall 27 is parallel to the direction of translation of the sliding means 13.

Each sliding wall 27 is parallel to the connecting pins 9, 11 and to each pin securing the respective friction sliding block 25; the sliding means 13 is provided with a hooking 23 for the elastic means 15 placed, with respect to the second connecting pin 11, in a manner for transmitting to each friction sliding block 25 an abutment torque pushing it 25 against the respective sliding wall 27. The elastic means 15 are, for example, of a compressed coil spring type having one end in abutment with a shelf or support 35 of the first connection means and having the opposite end acting, by a not shown internal rod guiding the spring, on the hooking 23 of the sliding means 13.

The arrest means 19 is fixed to or made in the first connection means 3 in proximity to the at least one sliding wall 27 to abut with the sliding means 13 or preferably with one of the at least one friction sliding block 25 arresting its stroke towards the closing of the door or of the shutter in correspondence of the breather opening condition S.

Preferably the hooking 23 for the elastic means 15 is placed in the sliding means 13 at the side of the latter 13 opposite, with respect to the second connection pin 11, to the friction sliding block 25 that is assigned to abut with the arrest means 19.

As shown in FIGS. 1-11, the hooking 23 and the straight line of action of the elastic force of the elastic means are offset with respect to a geometric straight line parallel to the motion of translation of the sliding means 13 and passing through the second connecting pin 11, and the at least one friction sliding block 25 are mutually offset so that the torque generated by the offset of the hooking 23 in respect to the connecting pin 11 is transmitted to, e.g., two friction sliding blocks 25 pressing them against the respective sliding walls 27. In the breather opening condition S the angle of rotation of the second connection means 5 and of the door compared to the closed condition C is generally between 8° and 20° and preferably it is about 11° as shown in FIG. 6; the longitudinal extension of the slot shaped seat 21 is such as to allow the rotation of the door of this latter angle when the arrest means 19 abut with the sliding means 13.

The operation of the device 1 provides that the door or shutter can achieve the breather opening condition S starting from the closed condition C through a slight push produced by an electrically controlled lock and it provides that the door can follow the opposite route through manual push or inertia.

This is allowed by the longitudinal extension of the slot shaped seat 21, that allows the free rotation of the door between the closed condition C and breather condition S putting the door out of the spring forces and friction applied to the sliding means 13 while the translation of the latter is blocked by the arrest means 19.

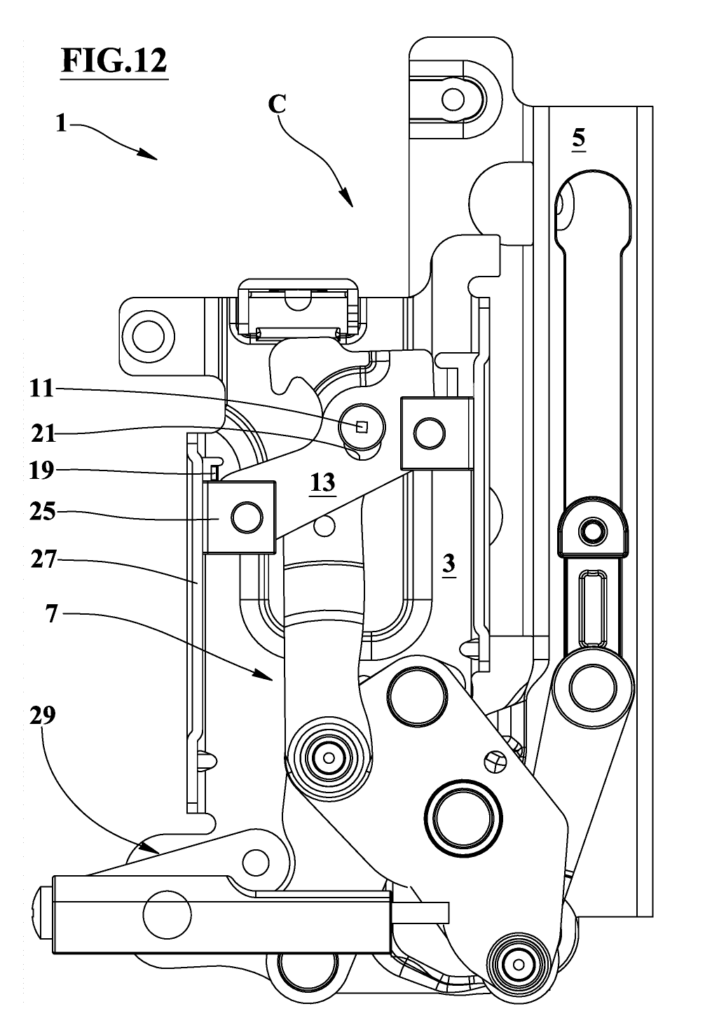

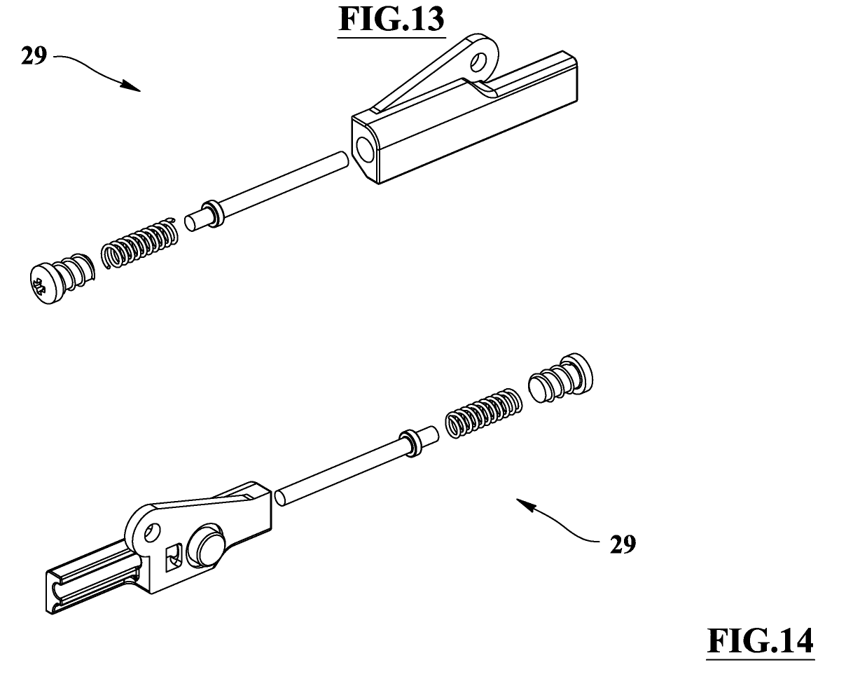

The interconnecting means 7 of the device of the variant of FIGS. 12 to 14, consists of a connecting rod or, as shown in FIG. 12, in a connection chain connecting rods and rocker.

This variant comprises a pusher means 29 equipped with an elastic means and assigned to act onto the interconnection means 7 with an elastic force intended to facilitate or to enable the achievement of the breather condition S of the door or shutter starting from the closed condition C. The pusher means 29 comprises a respective body fixed to the first connection means 3 and provided with a longitudinal cavity which houses a helical spring operating in compression and acting axially on a movable rod in said cavity whose outer end transmits the elastic force of the spring to the interconnection means 7 to provide the door with an elastic opening force from the closed condition C to the breather condition S.

The operation of this variant provides that, after the electric actuated opening of the lock door, the elastic force of the pusher means 29 allows or aids the rotation of the door from the closed condition C to the breather condition S.

1) Hinge device with the possibility of breather opening comprising
a first connection means (3) assigned to be fixed to a structure or frame and rotatably connected by a hinge pin (4) to
a second connection means (5) assigned to be fixed to a door or shutter;
at least one interconnecting means (7) having a first end connected to the second connection means (5) by a first connecting pin (9) and a second end connected by a second connecting pin (11) to
a sliding means (13) constrained to translate along the first connection means (3) and provided with elastic means (15) and with friction means (17) assigned to transmit to the second connection means (5), by the interconnecting means (7), respectively, an elastic force directed in a direction of an extreme closing condition (C) of the door or shutter and a frictional force directed opposite to the rotation of the door or of the shutter;
arrest means (19) assigned to abut with the sliding means (13) in an end portion of the rotation of the closing door or shutter arresting the sliding means (13) in correspondence of a breather opening condition (S) of the door or shutter, wherein the connecting pin (11) is housed with clearance in a respective seat (21) made in the second end of the interconnecting means (7) and slot shaped to allow the connection means and the door or shutter to carry out a final portion of a closing rotation of the door or shutter from the breather opening condition (S) to the extreme closing condition (C); wherein each friction means (17) comprises
at least one friction sliding block (25) secured to the sliding means (13) by a respective constraint pin and sliding along a respective sliding wall (27) of the first connection means (3) and parallel to the direction of translation of the sliding means (13);
wherein the at least one arrest means (19) is fixed to or made in the first connection means (3) in proximity to the at least one sliding wall (27) to abut with the sliding means (13) arresting its stroke towards the closing of the door or of the shutter in correspondence of the breather opening condition (S).

2) Device according to claim 1 wherein the friction means (17) provide to the second connection means (5) a friction force higher in intensity or in module to the elastic force given to the second connection means (5) by the elastic means (15).

3) Device according to claim 1 wherein the sliding means (13) comprises a rocker arm having a median portion that is engaged to the connecting pin (11).

4) Device according to claim 1 wherein each sliding wall (27) is parallel to the connecting pins (11) and to the constraint pin of each friction sliding block (25) and wherein the sliding means (13) is provided with a hooking (23) for the elastic means (15) placed, with respect to the connecting pin (11), in a manner for transmitting to each friction sliding block (25) an abutment torque against the respective sliding wall (27).

5) Device according to claim 1 wherein the hooking (23) for the elastic means (15) is placed in the sliding means (13) at the side of the latter (13) opposite, with respect to the second connection pin (11), to the friction sliding block (25) that is assigned to abut with arrest means (19).

6) Device according to claim 1 wherein the slot seat (21), made in the sliding means (13), for housing the second connection pin (11) is elongated approximately in the direction of the motion of the sliding means and has a longitudinal extension that allows the interconnecting means (7), the second connection means (5) and the door or the shutter to reach the closed condition (C) starting from the open breather condition (S) through manual pushing.

7) Device according claim 1 wherein the interconnecting means (7) comprises a connecting rod or of a series of connecting rod and a rocker arm.

8) Device according to claim 7 comprising a pusher means (29) comprising an elastic means and assigned to act on the interconnecting means (7) with an elastic force assigned to facilitate or to allow the achievement of the breather opening condition (S) of the door or of the shutter.
